(19) United States
(12) Patent Application Publication
(10) Pub. No.: US 2008/0050494 A1
(43) Pub. Date: Feb. 28, 2008

(54) Low pH, shelf-stable, milk-based food product

(76) Inventor: Richard S. Meyer, Federal Way, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/509,953

(22) Filed: Aug. 25, 2006

(51) Int. Cl. A23L 1/16

(52) U.S. Cl. 426/557

(57) ABSTRACT

An acidified, milk-based, shelf-stable food product comprises a milk-based component and preferably a pasta component. At least the milk-based component contains acidifying agents selected from the group of sodium acid sulfate, sorbic acid, lactic acid, and gluconic acid. This unique combination of acids provides a salty flavor without the addition of sodium chloride and provides an end product having a low pH or low acid taste that is shelf-stable over a significant period of time.

### BACKGROUND

The present invention relates to shelf-stable food products and more particularly to acidified, milk-based, shelf-stable food products suitable for consumption by human beings.

Typically, macaroni and cheese and other milk-based food products have a pH above 6.0. This high pH requires that the product be retorted (heated to 121° C. for at least 6 minutes) to sterilize the product. Retorting causes the cheese to scorch and ruins the end product. Thus, at present, there are no shelf-stable, ready-to-eat macaroni cheese products or other milk-based/carbohydrate combination products on the market.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matters.

The present invention provides a milk-based, shelf-stable food product that is acidified with a unique blend of acidifying agents that together do not give the end product a sour flavor. The preferred acidifying agents are selected from sodium acid sulfate, sorbic acid, lactic acid, and gluconic acid. Surprisingly, this combination of acids has a salty flavor rather than the typical sour flavor derived from a conventional acid blend. Thus, the products do not require the addition of salt (other than what is in the ingredients themselves). The salty flavor of the acids provides a salty taste that is very acceptable and pleasing to the average consumer. A typical milk-based product can be produced from a combination of (a) milk or cream, butter, and water; (b) a thickening agent; (c) flavorants; and (d) at least two of the four acidifying agents derived from the group consisting of sodium acid sulfate, sorbic acid, lactic acid, and glucono-delta-lactone. While the milk-based products can be produced by themselves, typically they are produced in combination with a carbohydrate component, usually pasta such as macaroni.

### DETAILED DESCRIPTION

The present invention comprises two major components, a milk-based component and a carbohydrate component. The milk-based component contains a unique blend of acids that acidify the milk-based component so that retorting is not required to produce a shelf-stable product. A carbohydrate component can be added to the milk-based component and can preferably include the same unique blend of acids that are utilized in the milk-based component. In combination, the acids provide a salty flavor without the addition of table salt (sodium chloride). Thus, the product made in accordance with the present invention can be advertised as a “low-salt” product, i.e., one that has a low sodium chloride content.

The unique blend of acidifying agents is selected from a group of four members: sodium acid sulfate, sorbic acid, lactic acid, and gluconic acid, which can be added directly or added as glucono-delta-lactone. Glucono-delta-lactone when added to water hydrolyzes to gluconic acid. In the present invention, when the term gluconic acid is used, it is intended to mean the compound itself or a precursor to the compound, such as glucono-delta-lactone. Sorbic acid and lactic acid are organic acids utilized in foods. Likewise, sodium acid sulfate is an inorganic salt that is also utilized in the preparation of food stuffs. These compounds are referred to herein as acidifying agents because in an aqueous environment all yield hydrogen ions that acidify the overall mixture. In accordance with the present invention, the acidifying agents preferably include both sodium acid sulfate and gluconic acid. While only one of these acids is required, best results are obtained when used in a gluconic acid/sodium acid sulfate weight percent blend of 80%-20%/20%-80%, and preferably 85%-55%/15%-45%. Sorbic acid may also be included in the blend of the acidifying agents. Good results are also achieved when lactic acid is also added to the group of acidifying agents.

The dairy-based component of the present invention may include milk (for flavored milk products such as chocolate milk), cream, sour cream, butter, cheese, cheese powder, and other milk-derived products. A preferred cheese-flavored component would include cream or sour cream, unsalted butter, water, and cheese powder, usually combined with citric acid. Other milk-based products include shelf-stable puddings and shelf-stable coffee creamers.

Additives that enhance the cheese flavor include starter distillates, which provide butter flavor, other butter enhancing agents, nucleic acids, monosodium glutamate, disodium inosinate, disodium guonylate, hydrolyzed vegetable proteins, and yeast extracts that provide a boost to the cheese flavor in the resulting product. In addition, an additive such as maltodextrin can be used. Maltodextrin adds a very slight sweetness and masks acid notes in the resulting product. Other low DE (dextrose equivalent lower than 5) products may be substituted for the maltodextrin. Such products include dextrin. If an enhanced salt flavor is desired, potassium chloride can also be added in lieu of sodium chloride. Potassium chloride provides a pseudo “salty” taste similar to that provided by sodium chloride.

In addition to the foregoing flavorants, thickening agents and stabilizers may also be added. The thickening agents can give the resulting milk-based component a creamy texture that does not separate and helps keep the component from being absorbed into the carbohydrate component as occurs with prior art retorted and boxed products. Suitable gums include xanthan gum, carrageenan, and locust bean gum, as well as alginates such as propylene glycol alginate.

In a typical product, the dairy-based component will include from 40%-50% of dairy-based products such as milk, sour cream, butter, and milk-based flavorants. A typical mixture will also contain on the order of 30%-35% water with the remaining ingredients comprised of the flavorants, additives, thickening agents, and acidifying agents. Typically, the acidifying agents will be included in an amount on the order of 1% of the total milk-based component. Each of the individual acidifying agents can be used in percentages of from 0.1%-0.5% and are preferably used in the range of 0.1%-0.25%. When maltodextrin is employed, it can be added in amounts ranging from 8%-12% and more preferably on the order of 9%-11% of the total milk-based component. Typically, the thickening agents are added in amounts of less than 1% and typically on the order of 0.5% or less. The cheese flavorants are typically added in the range of from 4%-8% and more preferably on the order of 5%-7% of the total milk-based component.

Acidification with the acidifying agents in accordance with the present invention produces a milk-based component that has a final pH on the order of from 2.6 to 4.5, preferably from 3.0 to 4.0, and most preferably from 3.6 to 4.0. This low pH does not require retorting and yields a shelf-stable product with pasteurization that has a pleasing taste. If desired, a carbohydrate-based component can be mixed with the milk-based component to provide the resulting product. Typical carbohydrate components include pastas such as macaroni and noodles. A typical product produced in accordance with the present invention would be a shelf-stable, acidified macaroni and cheese product.

In accordance with the present invention, the pasta component is cooked in boiling water that has been acidified with acidifying agents selected from the same acidifying agents used in the milk-based component. The pasta is prepared by bringing a predetermined quantity of water to a boil. The acidifying agents are then added. The pasta component is then added and boiled according to the directions provided by the pasta manufacturer. For example, an off-the-shelf Barilla macaroni would be boiled in four quarts of water for approximately seven minutes uncovered. The water would then be drained from the pasta component. It is important that the pasta component be immediately chilled to set the texture of the macaroni and prevent it from becoming soggy when the milk-based component or sauce is added. When this procedure is followed, the milk-based component is not absorbed into the pasta component as is the case with many retorted boxed products produced today. In accordance with the present invention, the pasta component stays firm and chewy (al dente), which is a desirable trait.

### EXAMPLES

The following examples are intended to teach one of ordinary skill how to make and use the invention. They are not intended in any way to limit the scope of the invention as determined by the claims appended hereto.

### Examples 1, 2, 3, and 4

Three blends of a cheese-flavored sauce were prepared with the ingredients set forth in Table 1 below.

TABLE 1

| Milk-Based, | | | | | | | | |
|---|---|---|---|---|---|---|---|---|
| Cheese-Flavored | Example 1 | | Example 2 | | Example 3 | | Example 4 | |
| Component | g. | % | g. | % | g. | % | g. | % |
| Wet Blend Together | | | | | | | | |
| Sour Cream (pH | 907.50 | 42.938% | 907.50 | 43.072% | 907.50 | 42.990% | 915.00 | 44.154% |
| 4.39) | | | | | | | | |
| Unsalted Butter | 113.44 | 5.367% | 113.44 | 5.384% | 113.44 | 5.374% | 113.44 | 5.474% |
| Water | 710.65 | 33.624% | 710.65 | 33.729% | 710.65 | 33.665% | 710.65 | 34.293% |
| DairyChem 15X | 1.70 | 0.080% | 1.70 | 0.081% | 1.70 | 0.081% | 1.70 | 0.082% |
| Starter Distillate | | | | | | | | |
| Diacetyl Natural | 0.10 | 0.005% | 0.10 | 0.005% | 0.10 | 0.005% | 0.10 | 0.005% |
| Butter Flavor | | | | | | | | |
| | | 0.000% | | 0.000% | | 0.000% | | |
| Dry Blend Together | | | | | | | | |
| Maltodextrin, 5 DE | 206.00 | 9.747% | 206.00 | 9.777% | 206.00 | 9.759% | 150.00 | 7.23% |
| (Tate & Lyle) | | | | | | | | |
| Challenge Brand | 136.70 | 6.468% | | 0.000% | | 0.000% | | 0.000% |
| Dairy Blend | | | | | | | | |
| BDF0132 | | | | | | | | |
| Challenge Brand | | 0.000% | 126.00 | 5.980% | | 0.000% | | 0.000% |
| Dairy Blend NP1368 | | | | | | | | |
| NS | | | | | | | | |
| Challenge Brand | | 0.000% | | 0.000% | 130.00 | 6.158% | 130.0 | 6.273% |
| Dairy Blend NP1378 | | | | | | | | |
| DSM Brand | 3.40 | 0.161% | 3.40 | 0.161% | 3.40 | 0.161% | 3.40 | 0.164% |
| Maxarome Plus 2491 | | | | | | | | |
| Gb Select Brand | 15.67 | 0.741% | 15.67 | 0.744% | 15.67 | 0.742% | 15.67 | 0.756% |
| Dairy Enhancer 6558 | | | | | | | | |
| Coyote Brand | 1.52 | 0.072% | | 0.000% | | 0.000% | | 0.000% |
| Xanthan/ | | | | | | | | |
| Polypropylene | | | | | | | | |
| Glycolalginate Blend | | | | | | | | |
| Lambda- | 1.80 | 0.085% | | 0.000% | | 0.000% | | 0.000% |
| Carrageenan, TIC* | | | | | | | | |
| Locust Bean Gum, | 0.55 | 0.026% | 0.50 | 0.024% | 0.50 | 0.024% | 1.25 | 0.060% |
| TIC* | | | | | | | | |
| Colloid 602, TIC* | | 0.000% | 2.50 | 0.119% | 2.50 | 0.118% | 3.00 | 0.145% |
| Polypropylene | | | | | | | | |
| Glycolalginate | | | | | | | | |
| Edlong Brand | | 0.000% | | 0.000% | | 0.000% | 2.15 | 0.104% |
| Natural Cheddar | | | | | | | | |
| Cheese #1433 | | | | | | | | |
| Xanthan Gum, TIC* | | 0.000% | 1.00 | 0.047% | 1.00 | 0.047% | 1.85 | 0.089% |
| Sodium Acid Sulfate | 4.00 | 0.189% | 4.00 | 0.190% | 4.00 | 0.189% | 9.08 | 0.438% |
| Sorbic Acid | 2.50 | 0.118% | 2.50 | 0.119% | 2.50 | 0.118% | 1.50 | 0.072% |
| Lactic Acid (88%) | 3.00 | 0.142% | 3.00 | 0.142% | 3.00 | 0.142% | | 0.000% |
| Glucono-delta- | 5.00 | 0.237% | 5.00 | 0.237% | 5.00 | 0.237% | 9.00 | 0.434% |
| lactone | | | | | | | | |
| Potassium Chloride | | 0.000% | 3.00 | 0.142% | 3.00 | 0.142% | 3.00 | 0.145% |
| TIC Colloid 6024 | | 0.000% | 1.00 | 0.047% | 1.00 | 0.047% | 1.5 | 0.072% |
| SGL Carrageenan | | | | | | | | |
| TOTAL | 2113.53 | 100.000% | 2106.96 | 100.000% | 2110.96 | 100.000% | | |

*TIC Gums brand

The sour cream, unsalted butter, water, starter distillate, and diacetyl natural butter flavor are placed in a high-speed blender and blended until the resulting mixture is homogeneous. The remaining ingredients are dry and are blended together until relatively homogeneous. The dry blend is then folded into the liquid blend and thoroughly mixed. The product is heated to 160° F. to 190° F. and held for a sufficient time to pasteurize the product (typically from 1 to 5 minutes); the higher the temperature is, the shorter is the time required for pasteurization. The sauces produced by Examples 1, 2, 3, and 4 had a final pH of 3.90, 3.90, 3.98, and 3.80, respectively.

Thereafter, one package (454 grams) of Barilla brand macaroni was placed in four quarts of water (3,629 grams) that had been brought to a boil. Acidifying agents were then added in the following amounts: 3.62 grams of glucono-delta-lactone, 1.8 grams of sorbic acid, 3.62 grams of starter distillate, and 3.62 grams of sodium acid sulfate. The macaroni was then added to the boiling water and boiled uncovered for seven minutes. The macaroni was then well drained. Butter (36.8 grams) was added to coat the macaroni and the macaroni was immediately cooled to room temperature. This procedure was repeated for each of Examples 1, 2, and 3. For each example, the pasta had a pH of 3.90, 3.90, and 3.98, respectively.

The sauces from each of Examples 1, 2, and 3 were then combined, respectively, with the macaroni in a 60/40 weight ratio (cooked pasta to sauce). The product was heated to 160° F. and held for 3 minutes and hot filled into sterile polyethylene/nylon pouches, and vacuum sealed. The combined products had a pH of about 3.90, 3.90, and 3.98, respectively.

The sodium content of each of the blends was measured. For 1 cup servings, the sodium content was 120 mg for each of Examples 1, 2, and 3.

The packages were then stored for a period of 10 days. No deterioration was noted during this period of time.

### Example 5

An Alfredo sauce was also prepared. The following ingredients were used to make sauce A and sauce B.

TABLE 2

Alfredo Sauce

| | A | B |
|---|---|---|
| Ingredients | g. | g. |
| Water | 241.00 | 241.00 |
| Cream, 35% fat | 225.00 | 225.00 |
| Salt | 0.00 | 0.00 |
| Potassium chloride | 3.00 | 3.00 |
| Nat'l. Ultra sperse M/Tate&Lyle | 12.75 | 12.75 |
| 606 | | |
| Edlong 1087 | 1.28 | 1.28 |
| Edlong 1369 | 2.56 | 2.56 |
| Edlong 1410304 | 0.25 | 0.25 |
| Dairychem 15X starter distillate | 0.50 | 0.50 |
| Diacetyl nat. butter flavor | 0.05 | 0.05 |
| Xanthan gum | 0.25 | 0.25 |
| Sugar | 7.50 | 7.50 |
| Onion powder | 1.00 | 1.00 |
| White pepper | 0.25 | 0.25 |
| Garlic powder | 1.00 | 1.00 |
| Fuchs Banalox rosemary extract | 0.10 | 0.10 |
| Sodium acid sulfate | 3.50 | 0.00 |
| Gluco delta lactone | 0.00 | 3.50 |
| TOTAL | 499.98 | 499.98 |

The Edlong brand products are commercially available parmesan cheese flavors. The Fuchs brand product is an antioxidant. Sauce A contains only sodium acid sulfate as an acidifier. Sauce B contains only glucono-delta-lactone.

These sauces were blended in weight percentages of A/B from 0 to 100/100 to 0. A taste test was conducted, and the best tastes were derived from a weight percent blend of glucono-delta-lactone/sodium acid sulfate of 80%-20%/20%-80% and, more preferably, 85%-55%/15%-45%.

While illustrative embodiments have been illustrated and described, it will be appreciated that various changes can be made therein without departing from the spirit and scope of the invention.

The embodiments of the invention in which an exclusive property or privilege is claimed are defined as follows:

1. An acidified, milk-based, shelf-stable food product having a pH from 2.6 to 4.5 comprising:
(a) cream, butter, and water;
(b) a thickening agent,
(c) a flavorant; and
(d) at least two of the four acids or acid salts derived from the group consisting of sodium acid sulfate, sorbic acid, lactic acid, and gluconic acid.

2. The product of claim 1 wherein the acids comprise sodium acid sulfate and gluconic acid.

3. The product of claim 2, further comprising lactic acid.

4. The product of claim 2, further comprising an edible carbohydrate component.

5. The product of claim 4 wherein the carbohydrate component is a pasta.

6. The product of claim 5 wherein the pasta is macaroni.

7. The product of claim 6 consisting essentially of sodium chloride present in the added components with no added sodium chloride.

8. An acidified, milk-based, shelf-stable food product having a pH of from 2.6 to 4.4 comprising:
(a) a dairy-based component;
(b) additives selected from the group consisting of flavorants and thickeners; and
(c) acids or acid salts derived from the group consisting of sodium acid sulfate, sorbic acid, lactic acid, and gluconic acid.

9. The product of claim 8 wherein the acids are derived from sodium acid sulfate and gluconic acid.

10. The product of claim 9 wherein the acids are further derived from lactic acid.

11. The product of claim 8 wherein the flavorant is cheese flavored.

12. The product of claim 11 wherein the thickener comprises gums.

13. The product of claim 8 wherein the dairy-based component comprises milk.

14. The product of claim 8 wherein the dairy-based component comprises sour cream.

15. The product of claim 14 wherein the flavorant is cheese flavored.

16. The product of claim 15 wherein the product further comprises a carbohydrate component.

17. The product of claim 16 wherein the carbohydrate is pasta.

18. The product of claim 17 wherein the carbohydrate is macaroni.

19. The product of claim 18 comprising no added sodium chloride.

20. The product of claim 1 or 8 having a pH of 3.0 to 4.0.

21. The product of claim 1 or 8 having a pH of 3.6 to 3.9.
